(19) United States
(12) Patent Application Publication
(10) Pub. No.: US 2016/0189878 A1
(43) Pub. Date: Jun. 30, 2016

(54) Method for manufacturing tantalum-silver composite electrode having high corrosion resistance for dye-sensitized solar cell using lower-temperature molten salt electroplating method

(71) Applicants: Hyundai Motor Company, Seoul (KR); The Industry & Academic Cooperation in Chungnam National University (IAC), Daejeon (KR)

(72) Inventors: Kyoung Jin Jeong, Seoul (KR); Young Jun Lee, Daejeon (KR); Jong Hyeon Lee, Daejeon (KR)

(21) Appl. No.: 14/998,326

(22) Filed: Dec. 24, 2015

(30) Foreign Application Priority Data
Dec. 24, 2014 (KR) 10-2014-0188292

(51) Int. Cl. H01G 9/20; C25D 7/12

(52) U.S. Cl. CPC H01G 9/2022; C25D 7/12

(57) ABSTRACT

The present invention relates to a method for manufacturing a tantalum-silver composite electrode: The method comprises:(a) preparing a molten salt; (b) disposing a corrosion-resistant metal on an anode; (c) disposing a base substrate on a cathode; (d) inserting the corrosion-resistant metal and the base substrate into the molten salt; and (e) electrodepositing the corrosion-resistant metal on the base substrate by applying a current density to the base substrate. In particular, the molten salt has a lower melting temperature, the corrosion-resistant metal is tantalum, and the base substrate is a substrate comprising silver.

### CROSS-REFERENCE TO RELATED APPLICATION

This application claims under 35 U.S.C. §119(a) the benefit of Korean Patent Application No. 10-2014-0188292 filed on Dec. 24, 2014, the entire contents of which are incorporated herein by reference.

### TECHNICAL FIELD

The present invention relates to a method for manufacturing a tantalum-silver composite electrode. In particular, the tantalum-silver composite electrode may be manufactured by a molten salt electroplating method, such that the electrode may have substantially improved corrosion resistance.

### BACKGROUND

A dye-sensitized solar cell (DSSC) is semi-transparent and relatively less sensitive to the amount of solar illumination. Further, due to excellent power generation properties, the DSSC may be used as an auxiliary power system as being installed in interior/exterior of vehicles. However, durability of the DSSC may decline due to problems such as electrode corrosion caused by an iodine component in a liquid electrolyte used in a solar cell, and thus, commercialization of the DSSC has been delayed.

In the related arts, dye-sensitized solar cell electrodes based on carbon nanotubes (CNT) have been disclosed in the U.S. Patent Application Laid-Open Publication No. 2013-0240027, the Korean Patent No. 1195761, and the Korean Patent No. 1224845. The dye-sensitized solar cell electrodes using carbon nanotubes has improved stability by preventing electrode corrosion, however, still has an electrolyte contamination problem due to mechanical properties (strength) and weak adhesive strength.

Meanwhile, dye-sensitized solar cell electrodes using a glass frit coating method also have been disclosed in the Korean Patent No.1130614 and the U.S. Pat. No. 08,525,155. However, a glass frit coating method may not be applicable to a flexible industry due to decreased energy conversion efficiency, substantial thickness thereof, e.g. 40 μm or greater, and lack of flexibility.

The above information disclosed in this Background section is only for enhancement of understanding of the background of the invention and therefore it may contain information that does not form the prior art that is already known in this country to a person of ordinary skill in the art.

### SUMMARY

In preferred aspects, the present invention provides a method to prevent silver grid corrosion that may occur in the related arts. The method of the present invention may uniformly form a tantalum coating layer which may provide substantially improved corrosion resistance and conductivity properties. In particular, the method of the present invention may use a molten salt.

The molten salt, as used herein, may refer to a molten form of a salt. The salt of the present invention may melt at a temperature of about 200° C. to 600, of about 250° C. to 550° C., of about 300° C. to 500° C., or particularly of about 380° C. to 450° C. Thus, the molten salt can be prepared by heating the salt to the above described temperature ranges. Further, thus prepared molten salt of the present invention may not react with or influence on a glass substrate of an electrode structural member in a dye-sensitized solar cell which may be vulnerable to high temperatures.

In one aspect, the present invention provides a method for manufacturing a tantalum-silver composite electrode, and the method may include: (a) preparing a molten salt; (b) disposing a corrosion-resistant metal on an anode; (c) disposing a base substrate on a cathode; (d) inserting the corrosion-resistant metal and the base substrate into the molten salt; and (e) electrodepositing the corrosion-resistant metal on the base substrate by applying a current density to the base substrate. In particular, the corrosion-resistant metal may be tantalum, and the base substrate may be a substrate comprising silver.

Preferably, the molten salt may include a LiCl—SrCl₂—CsCl electrolyte.

Further, in particular, the LiCl—SrCl₂—CsCl electrolyte may include an amount of about 60 mol % of LiCl, an amount of about 10 mol % of SrCl₂, and an amount of about30 mol % of CsCl, based on the total mole content of the molten salt.

Preferably, TaF₅ may be added into the molten salt to maintain an ion concentration of the tantalum in the molten salt. In particular, the TaF₅ may be added in an amount of about 1 to 2 mol %, based on the total mole content of the molten salt.

As such, a melting temperature of the molten salt may be in a range from about 380° C. to about 450° C.

Preferably, the step (e) may be carried out at a temperature of 400° C. to 450° C., and in the step (e), the electrodepositing may be carried out under an argon atmosphere in which oxygen and moisture are controlled.

In another aspect, the present invention provides a tantalum-silver composite electrode manufactured using the method described above.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1A-1B show exemplary components of an exemplary working electrode and an exemplary counter electrode according to an exemplary embodiment of the present invention;

FIG. 2 shows an exemplary ternary phase diagram for preparing a molten salt electrolyte comprising LiCl—SrC₂—CsCl according to an exemplary embodiment of the present invention;Cl

FIG. 3 shows an exemplary molten salt electroplating device;

FIGS. 4A-4B are exemplary graphs showing an analysis result on a LiCl—CsCl—SrC₂ molten salt and a LiCl—CsCl—SrC₂—TaF₅ molten salt according to exemplary embodiments of the present invention using a cyclic voltammetry (CV) method to measure an electrochemical reduction behavior of Ta;

FIG. 5 is an exemplary graph describing a chronopotentiometry experimental analysis result to optimize a condition in an exemplary coated film forming process according to an exemplary embodiment of the present invention;

FIG. 6 shows an exemplary coated film using an SEM after carrying out a molten salt electroplating according to an exemplary embodiment of the present invention;

FIGS. 7A-7D shows exemplary microscopic views of SEM analysis of a surface and a cross-section of exemplary tantalum coated film depending on applied current density according to exemplary embodiments of the present invention. In FIG. 7A, an exemplary specimen coated in a TaF₅ concentration of 0.5 mol % is shown, and in FIG. 7B, an exemplary specimen coated in a TaF₅ concentration of 1 mol % is shown, according to exemplary embodiments of the present invention;

FIGS. 8A-8D shows exemplary microscopic views of SEM analysis of a surface and a cross-section of exemplary tantalum coated film depending on applied current density according to exemplary embodiments of the present invention. In FIG. 8A, an exemplary specimen coated in a TaF₅ concentration of 0.5 mol % is shown, and in FIG. 8B, an exemplary specimen coated in a TaF₅ concentration of 1 mol % is shown, according to exemplary embodiments of the present invention;

FIGS. 9A-9B show exemplary graphs showing potential applied to a working electrode and a counter electrode which are formed by the molten salt electroplating method according to an exemplary embodiment of the present invention. In FIG. 9A, TaF₅ is included in an amount of 0.5 mol %, and in FIG. 9B, TaF₅ is included in an amount of 1 mol %; and

FIG. 10A shows an exemplary autoclave for a corrosion acceleration test, and FIG. 10B shows an exemplary specimen used in the corrosion test.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims. In describing the present invention, detailed descriptions for relating known technologies are not included when it is decided that the detailed descriptions may cloud the gist of the present invention.

The present invention provides a method for manufacturing a tantalum-silver composite electrode including (a) preparing a molten salt; (b) disposing a corrosion-resistant metal on an anode; (c) disposing a base substrate on a cathode; (d) inserting the corrosion-resistant metal and the base substrate into the molten salt; and (e) electrodepositing the corrosion-resistant metal on the base substrate by applying current density to the base substrate. In particular, the corrosion-resistant metal may be tantalum, and the base substrate may be a substrate comprising silver.

Particularly, the salt, as used herein, may have a melting temperature that is lower than a typical salt. For example, the salt may melt at a temperature of about 200° C. to 600, of about 250° C. to 550° C., of about 300° C. to 500° C., or particularly of about 380° C. to 450° C. Thus, the molten salt may be prepared at the above melting temperatures, which may be reduced from the typical melting process for salts. Further, thus prepared molten salt of the present invention may not react with or influence on any structural members in electroplating/electrodeposition device. Further, the thus prepared molten salt may not chemically react with the corrosion-resistant metal and the base substrate inserted therein. In particular, the molten salt, as used herein, may have fluidity and electric conductivity, such that may serve as an electrolyte (electrolyte bath) when electric current is applied.

In addition, the corrosion-resistant metal, as used herein, may provide corrosion resistance to the manufactured composite electrode against chemical or electrochemical oxidation which may occur during the course of electrode life span. Further, the corrosion-resistant metal, as used herein, may be oxidized into ion state, then upon applying the charge density or electric current, may be reduced into a solid metal phase, such the corrosion-resistant metal can be electrodeposited or electroplated on on other substrate. Exemplary corrosion resistant metal of element may include a transition metal, or a transition metal in period 6, or particularly tantalum.

Further, the base substrate, as used herein, may be a substrate or pattern comprising silver. Generally, the base substrate used in dye-sensitized solar cell (DSSC) is substrate or pattern having pattern width of 50˜200 μm and pattern height of 10˜30 μm, and comprising silver. But, a pure silver plate(silver specimen) is used in Example of the present invention.

In addition, further provided is a tantalum-silver composite electrode that is manufactured using the above-mentioned method.

Hereinafter, the method for manufacturing a tantalum-silver composite electrode according to specific embodiments of the present invention will be described in more detail.

The method for manufacturing a tantalum-silver composite electrode may include: (a) preparing a molten salt; (b) disposing a corrosion-resistant metal on an anode; (c) disposing a base substrate on a cathode; (d) inserting the corrosion-resistant metal and the base substrate into the molten salt; and (e) electrodemiting the corrosion-resistant metal on the base substrate by applying current density to the base substrate, wherein the corrosion-resistant metal is tantalum, and the base substrate is a substrate comprising silver.

The molten salt may be prepared by applying heat to a salt of the invention at a temperature of about 200° C. to 600, of about 250° C. to 550° C., of about 300° C. to 500° C., or particularly of about 380° C. to 450° C. In particular, the salt may melt at a temperature of about 380° C. to 450° C.

Preferably, a tantalum-coated film may be formed using the molten salt electroplating method.

Tantalum may be disposed on an anode (galvanic anode), and the base substrate on which the tantalum-coated film is formed may be disposed on a working electrode (a cathode).

The cathode and the base substrate may be connected by a tantalum wire, and the tantalum wire may be connected to the base substrate by being sintered using a silver adhesive material. When disposing a tantalum wire on a base substrate through sintering with a silver adhesive material, portions not having a coated film may not be present when the tantalum coated film is electrodeposited on the base substrate.

Electroplating may be carried out by inserting the tantalum and the base substrate disposed as above into the molten salt formed with different chloride-based electrolytes, and then applying a current.

The molten salt may include lithium chloride (LiCl), cesium chloride (CsCl), and strontium chloride (SrCl₂) at a suitable composition ratio. Further, an electrolyte may comprise an amount of about 60 mol % of LiCl, an amount of about 10 mol % of SrCl₂ and an amount of about 30 mol % of CsCl, based on the total mole content of the molten salt. The molten salt may be used to reduce electric power consumption for maintaining the molten salt at a low-temperature as liquid phase, and to increase a diffusion rate.

Further, TaF₅ may be added into the molten salt in order to maintain equilibrium of an tantalum ion concentration between reduction and oxidation state of the tantalum. The TaF₅ may be suitably added in an amount of about 1 to 2 mol %, based on the total mole content of the molten salt.

When the TaF₅ is added greater than the above-mentioned range, the TaF₅ may be deposited in a form of a porous powder. When the TaF₅ is added in an amount of about 1 to 2 mol %, a metal may be suitably reduced to form a dense metal film for protecting an Ag electrode.

In addition, the salt may have a melting temperature from about 380° C. to about 450° C. to maintain the molten salt as liquid phase. As such, stability of a glass substrate may be maintained when used in a dye-sensitized solar cell, and the temperature may be freely selected within the above-mentioned temperature range in forming a dense metal film with a purpose of protecting an Ag electrode.

Moreover, the step (e) may be carried out at a temperature of about 400° C. to 450° C.

In addition, the step (e) may be carried out under an argon atmosphere in which oxygen and moisture are controlled.

Preferably, a corrosion-resistant metal formed on an Ag electrode for protecting the Ag electrode may include zirconium, niobium and tungsten, such that the applied current density may vary based on a potential difference between oxidation state and reduction state of each metal.

Hereinafter, the present invention will be described focusing on the process of forming a coated film on the base substrate using tantalum and tungsten.

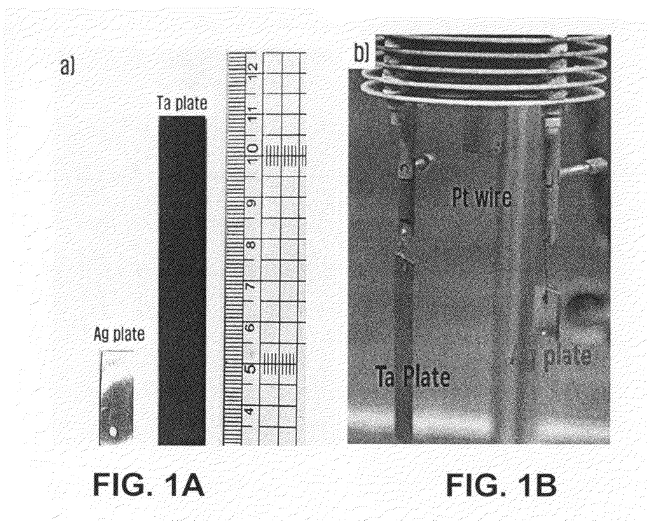

FIGS. 1A-1B show an exemplary working electrode and an exemplary counter electrode according to an exemplary embodiment of the present invention. Particularly, FIG. 1B demonstrates that electroplating may be carried out after disposing tantalum, an electrodepositing material, on an anode, and disposing a substrate comprising silver on a cathode.

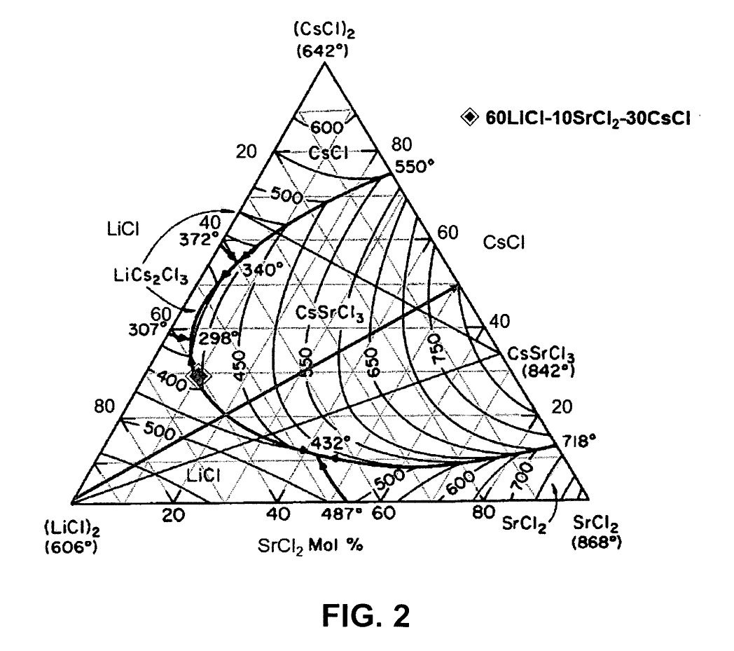

FIG. 2 shows a ternary phase diagram for preparing a molten salt electrolyte comprising LiCl—SrCl₂—CsCl according to an exemplary embodiment of the present invention. After determining a suitable composition of the molten salt from the diagram in FIG. 2, the powder is mixed, moisture in the power is removed through heat treatment, and electroplating may be carried out after inserting the result into a glove box in which an argon atmosphere is formed.

According to the present invention, a tantalum-silver composite electrode manufactured according to the above-mentioned method is provided. The tantalum-silver composite electrode may be for a dye-sensitized solar cell.

### EXAMPLES

Hereinafter, preferred examples of the present invention will be described in detail with reference to attached drawings. However, these examples are for illustrative purposes only, and the scope of the present invention is not interpreted to be limited to these examples.

Preparation Example

### Preparation of Electrolyte for Molten Salt Electroplating Method

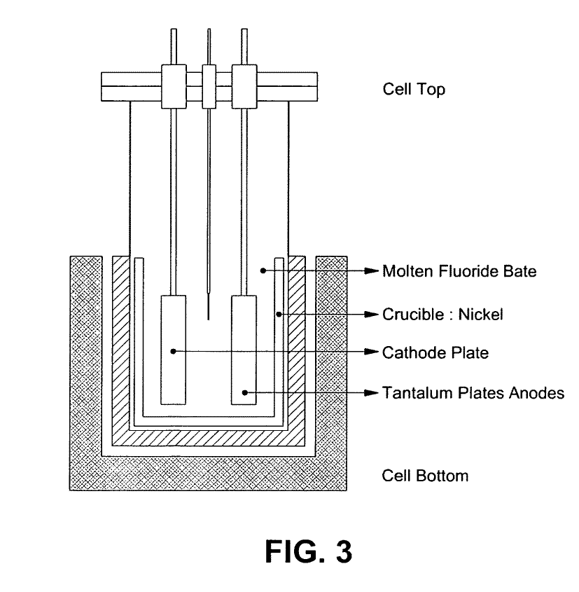

In a molten salt electroplating method according to an exemplary embodiment of the present invention, LiCl, CsCl, and SrCl₂ were weighted to have a chemical composition, i.e. 60 mol % LiCl, 10 mol % SrCl₂, 30 mol % CsCl, heat treated for 24 hours at 100° C. in order to remove moisture present in the powder, then heat treated again at a temperature of 350° C. in order to remove water of crystallization. Subsequently, the molten salt was prepared by adding 1 mol % of TaF₅ to the heat treated powder in order to maintain an equilibrium of Ta ion concentration in an electrolyte in an electroplating device manufactured as shown in FIG. 3 at 450° C. which is a melting temperature of the salt composition of 60 mol % LiCl, 10 mol % SrCl₂, 30 mol % CsCl as determined from the phase diagram of FIG. 2. In addition, the molten salt was prepared to have a 70% volume of a cell volume in order to prevent salt overflow when an electrode was inserted to the cell during electrodepositing.

### Example

As a base metal for coating, a commercially-available silver specimen was processed (0.1 t×1 W×2H) to be suitable for tests as in FIG. 1A, and was polished using a sand paper #800 in order to enhance an adhesive property of the tantalum and the silver substrate, and to enhance uniformity of a coating thickness. In addition, a tantalum plate as a galvanic anode was used as a counter electrode, and platinum (Pt) was used as a reference electrode in order to maintain an equilibrium state of the Ta concentration of the electrolyte.

An electroplating process electrode constitution according to an exemplary embodiment of the present invention is as shown in FIG. 1B, and electrodepositing was carried out under an argon (Ar) atmosphere in order to suppress the occurrence of an oxidized film of the base metal, and to prevent the corrosion of the device. The electrodepositing was carried out at a temperature of 450° C. in order to maintain equilibrium state of the TaF₅ in a liquid state, and promote movements of Ta ions in the electrolyte.

### Test Example 1

### Electrochemical Property Analysis on Molten Salt (LiCl—CsCl—SrCl₂—TaF₅)

In order to identify an electrochemical reduction behavior of Ta, cyclic voltammetry (CV) method was carried out for a LiCl—CsCl—SrCl₂ molten salt in which Ta ions were not present, and a LiCl—CsCl—SrCl₂—TaF₅ molten salt in which TaF₅ was added in 0.5 mol % and 1 mol %.

A tungsten (W) wire (99.95%, 0.5 mm (0.2 inch)) was used as a working electrode, and a W plate was used as a counter electrode.

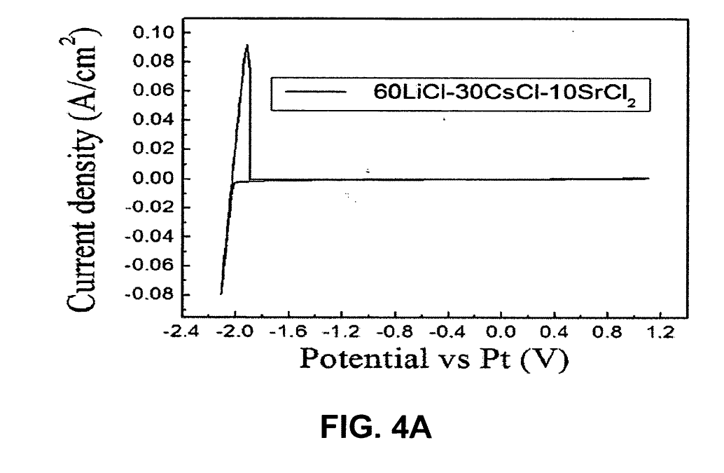

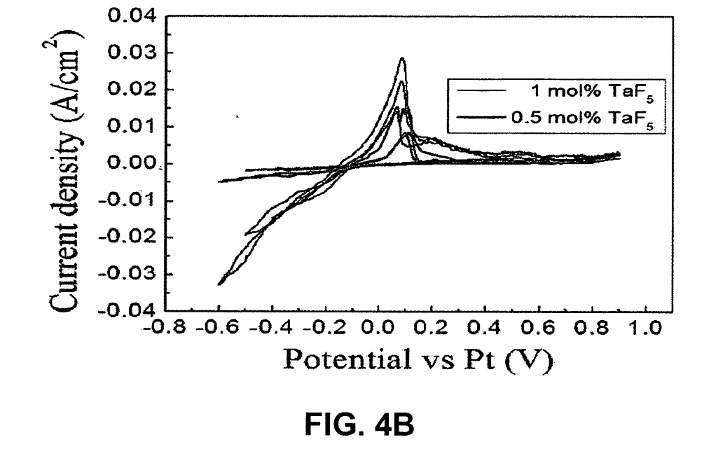

From the test results, it was identified that the electrolyte was decomposed at −2.1 V in the case of the electrolyte having no Ta ions, as in FIG. 4A. In the case of FIG. 4B in which TaF₅ was added, it was shown that Ta ions were reduced at −0.12 V or less in the molten salt in which TaF₅ was added in 0.5 mol % and 1 mol %.

A reduction reaction from Ta (V) to Ta (III) occurring at potential of −0.12 V and a reduction reaction of Ta (III) to a metal Ta occurring at potential of −0.27 V, which are shown in FIGS. 4A-4B, are disclosed in a literature of M. Mehmood et al. (“Electro-Deposition of Tantalum on Tungsten and Nickel in LiF—NaF—CaF₂ Melt Containing K2TaF7-Electrochemical Study”, Materials Transactions, 44(2), 259-267, 2003).

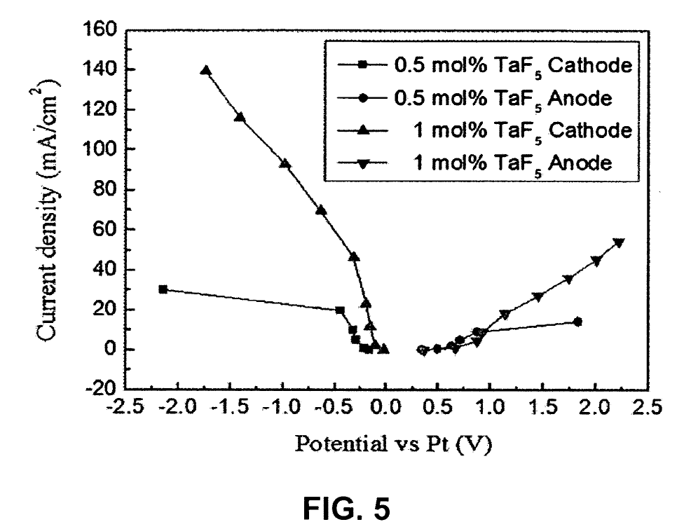

A chronopotentiometry test was carried out for a voltage-current curve graph of FIG. 5 in order to set up a condition of the Ta/Ag coating process. As a test result, concentration polarization rapidly increased at 20 mA/cm² in the case of 0.5 mol % of TaF₅, and a very stable tendency was shown even at applied current density of 140 mA/cm² in the case of 1 mol % of TaF₅. That may be resulted from the fact that Ta ions required for electrodepositing are sufficiently present in an electrolyte.

In the present invention, it is preferable that coating be carried out at a concentration of 1 mol % or greater of TaF₅ in a molten salt electroplating process.

### Test Example 2

### Analysis on Tantalum Coated Film Properties using Molten Salt Electroplating Method

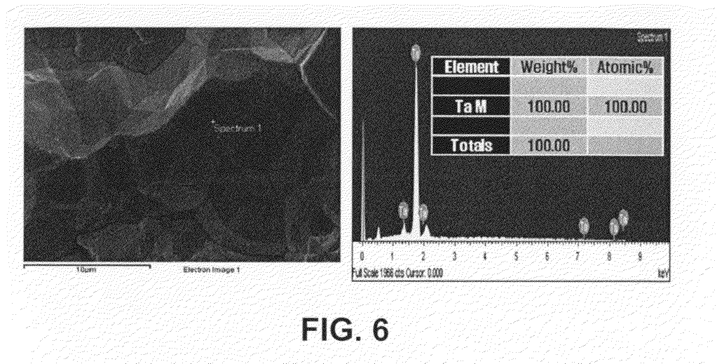

In the present invention, analysis on the tantalum coated film properties depending on the different applied current density was carried out as shown in Table 1 below using a molten salt electroplating method. As a result of the analysis, it was identified that a pure tantalum coated film was formed on the silver substrate as shown in the EDS analysis result of FIG. 6.

TABLE 1

| Current Density | | Designed Coating Thickness |
|---|---|---|
| (mA/cm²) | Operation Time (min) | (μm) |
| 1 | 1091 | 15 |
| 10 | 109.1 | 15 |
| 20 | 54.5 | 15 |
| 40 | 27.2 | 15 |

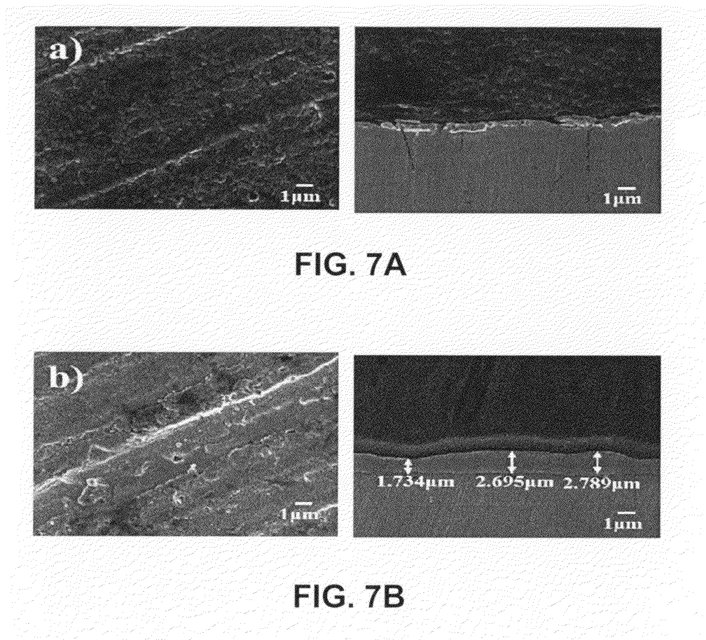

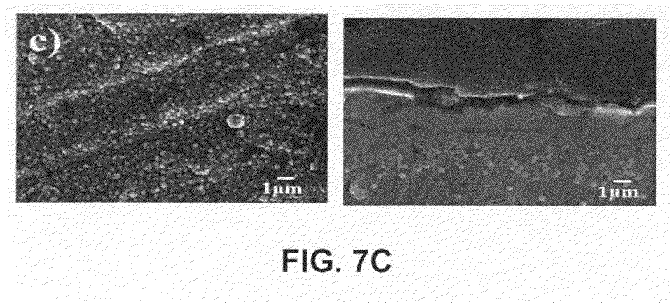

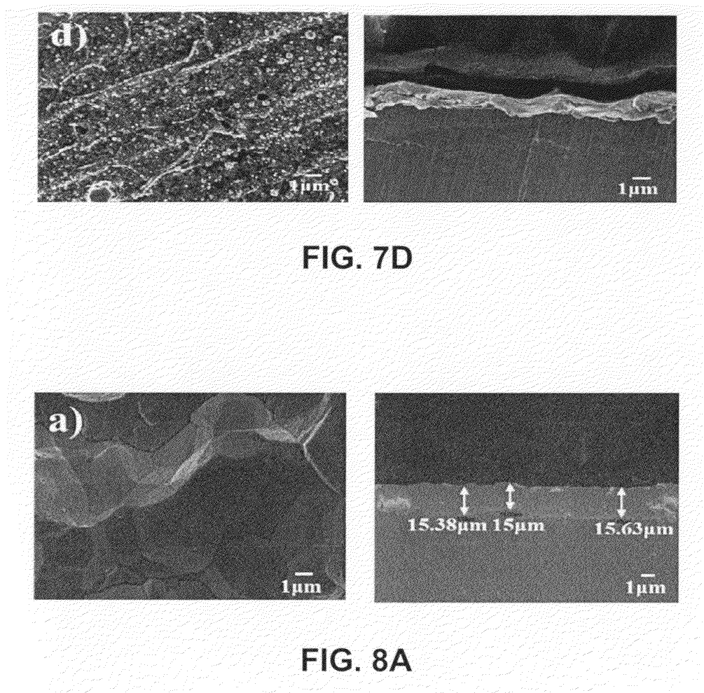

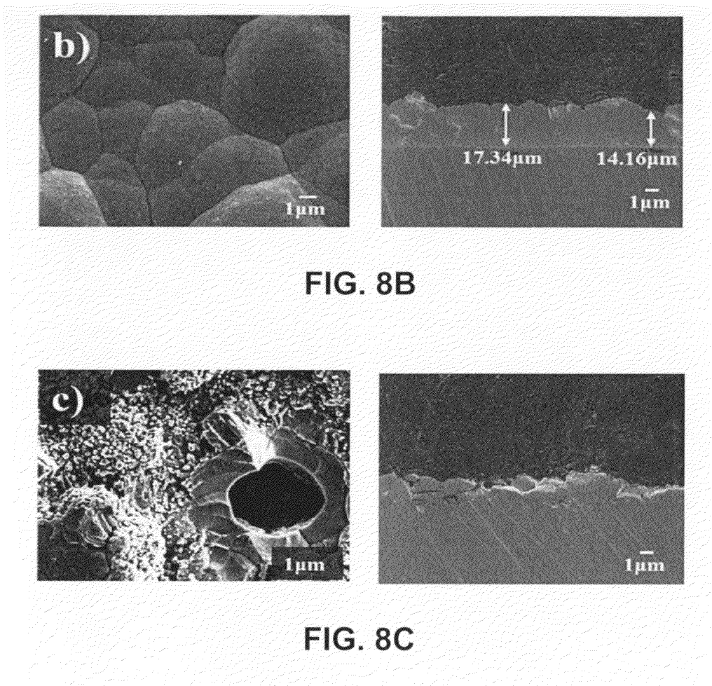

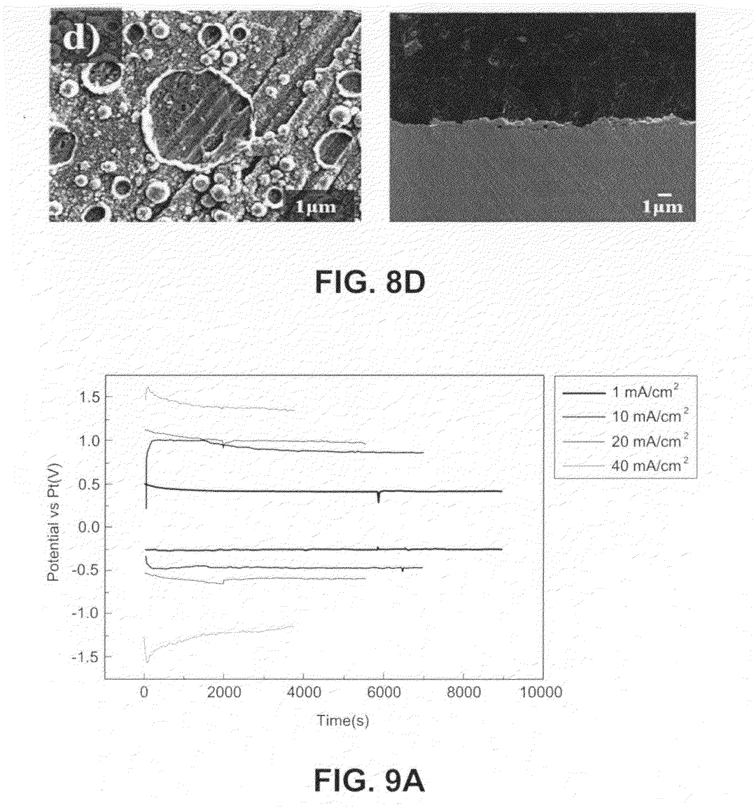

In addition, SEM results depending on each current density are shown in FIGS. 7A-7D and FIGS. 8A-8D. When the concentration of the TaF₅ was 0.5 mol % (FIG. 7), the coating surface was not uniform at all current density, and the coating layer thickness also did not reach a target thickness with being 2.412 μm±0.237,which may be from the fact that potential of −0.27 V in which Ta is reduced to a metal was formed in the working electrode. However, a non-uniform and porous coating layer was formed due to low Ta ion supply caused by a low Ta ion concentration in the electrolyte.

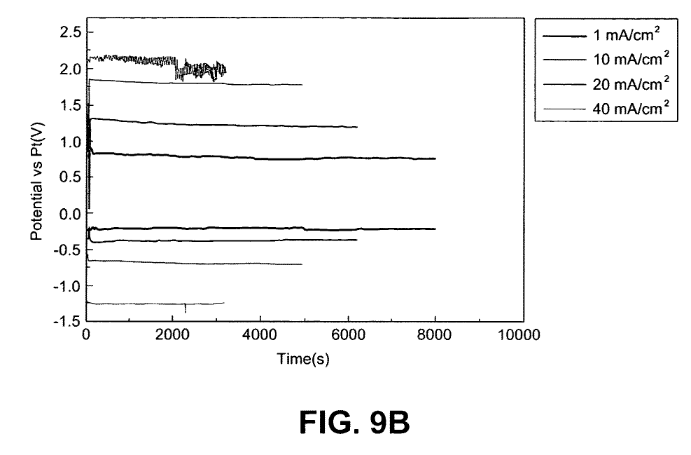

Meanwhile, when the concentration of the TaF₅ was 1 mol %, it was identified that a very uniform and dense Ta coating layer was formed at applied current density of 1 to 10 mA/cm² as shown in FIGS. 8A and 8B, which may be resulted from the fact that potential applied to the cathode was constantly maintained at −0.26 to −0.39 V, which is sufficient for Ta to be reduced, and Ta ion supply was also smooth, as shown in FIGS. 9A-9B.

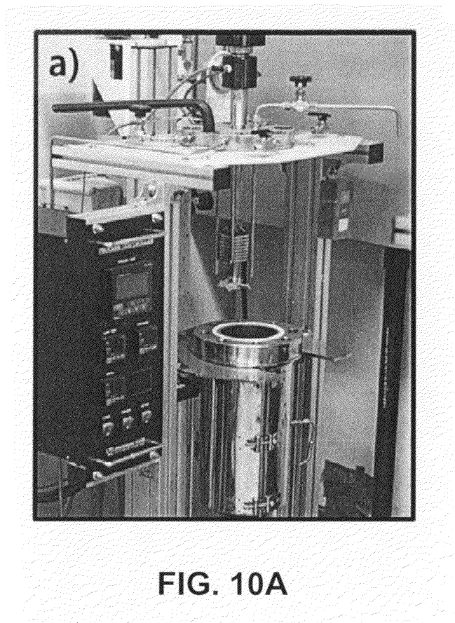

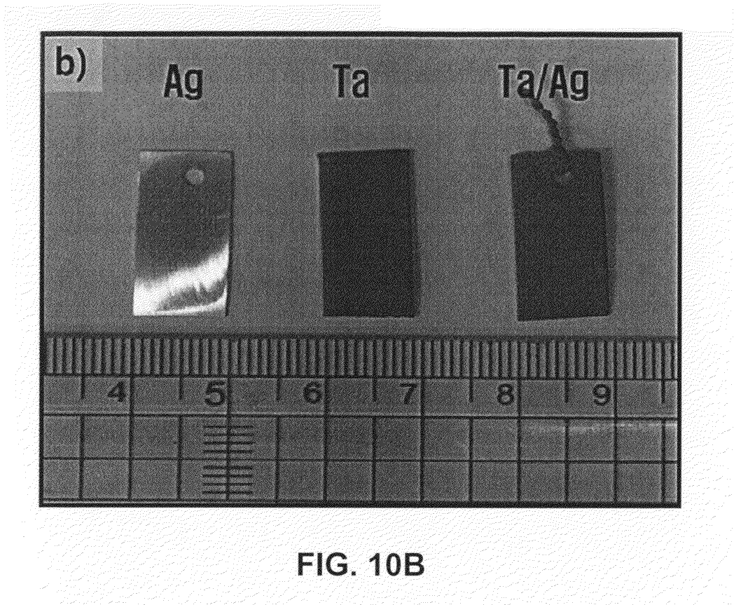

However, when applied current was 20 to 40 mA/cm², it was considered that a non-uniform and porous Ta coated film was formed since ion supply was not sufficient due to rapid electrodepositing despite a short process time with high current density. Particularly, when applied current was 40 mA/cm², potential applied to the electrode was not constant as shown in FIG. 10B.

### Test Example 3

### Corrosion Test on Ta-Ag Coated Film

In order to test corrosion resistance for each current density, corrosion tests were carried out for electrodeposited Ta/Ag, pure Ta, and pure Ag specimen under a condition of 1 mol % TaF₅−1 mA/cm² shown in FIG. 10B in an autoclave of FIG. 10A (10 h, 150° C., 2 MPa, HI=26.1, I₂=51.8, CH₃OH=22.0 wt %). Calculation of a corrosion loss rate follows the following Mathematical Equation 1.

mm/year=87.6×[W/(D×A×T)] [Mathematical Equation 1]

(W is a weight loss (milligram) before and after the corrosion, D is density of the sample (g/cm²), A is an area of the sample (cm²), and T is time of the corrosion test (h))

From the results of the corrosion tests, it was seen that the pure Ag specimen had a corrosion loss rate of 122 mm/year, which is not suitable to be used in a dye-sensitized solar cell as shown in the following Table 2.

Meanwhile, the Ta/Ag coated specimen prepared in the present invention had 0.0225 mm/year, and showed similar corrosion resistance with the pure Ta specimen value of 0.0112 mm/year.

TABLE 2

| | Weight of Before | Weight of After | Corrosion Rate |
|---|---|---|---|
| Material | Corrosion Test (g) | Corrosion Test (g) | (mm/year) |
| Ta/Ag | 1.2249 | 1.2247 | 0.0225 |
| Ta | 1.5664 | 1.5663 | 0.0112 |
| Ag | 0.819 | 0.146 | 122.175 |

Accordingly, since the tantalum-silver composite electrode can be manufactured using a molten salt electrodepositing process, a next-generation panorama roof can be produced and such a problem of silver grid corrosion caused by an electrolyte (I⁻/I₃⁻) used in dye-sensitized solar cell electrodes can be prevented.

According to the present invention, a tantalum-silver composite electrode may have substantially improved corrosion resistance and conductivity compared to an conventional silver electrode in the related arts for a dye-sensitized solar cell. In particular, the tantalum-silver composite electrode can be manufactured by forming, a uniform and dense tantalum coated film having improved corrosion resistance and conductivity using an electroplating method.

In addition, electrolyte contamination and deterioration of adhesive strength in conventional carbon nanotube-based dye-sensitized solar cell can be solved according to various exemplary embodiments of the present invention.

Moreover, according to exemplary embodiments of the present invention, a thinner and more flexible tantalum coated film having substantially improved corrosion resistance and conductivity may be formed compared to a method using a glass frit such that a corrosion problem of conventional silver grid electrodes can be solved. Therefore, the present invention provides effective method to produce a compact and flexible composite electrode structural member.

The invention has been described in detail with reference to preferred embodiments thereof. However, it will be appreciated by those skilled in the art that these specific descriptions are only preferred embodiments, and the scope of the present invention is not limited thereto. Therefore, changes may be made in these embodiments without departing from the principles and spirit of the invention, the scope of which is defined in the appended claims and their equivalents.

What is claimed is:

1. A method for manufacturing a tantalum-silver composite electrode, comprising:
(a) preparing a molten salt;
(b) disposing a corrosion-resistant metal on an anode;
(c) disposing a base substrate on a cathode;
(d) inserting the corrosion-resistant metal and the base substrate into the molten salt; and
(e) electrodepositing the corrosion-resistant metal on the base substrate by applying a current density to the base substrate,
wherein the corrosion-resistant metal is tantalum, and the base substrate is a substrate comprising silver.

2. The method of claim 1, wherein the molten salt includes a LiCl—SrCl₂—CsCl electrolyte.

3. The method of claim 2, wherein the LiCl—SrCl₂—CsCl electrolyte comprises an amount of about 60 mol % of LiCl, an amount of about 10 mol % of SrCl₂, and an amount of about30 mol % of CsCl.

4. The method of claim 1, further comprising adding TaF₅ into the molten salt in order to maintain an equilibrium state of the tantalum ion in the molten salt.

5. The method of claim 4, wherein the TaF₅ is added in an amount of about 1 to 2 mol % based on the total content of the molten salt.

6. The method of claim 1, wherein the molten salt is prepared at a temperature from about 380° C. to about 450° C.

7. The method of claim 1, wherein the step (e) is carried out at a temperature of about 400° C. to 450° C.

8. The method of claim 1, wherein the step (e) is carried out under an argon atmosphere in which oxygen and moisture are controlled.

9. A tantalum-silver composite electrode manufactured by a method of claim 1.

10. A dye-sensitized solar cell that comprises a tantalum-silver composite electrode of claim cm 9.
